(19) United States
(12) Patent Application Publication
(10) Pub. No.: US 2003/0195872 A1
(43) Pub. Date: Oct. 16, 2003

(54) Web-based information content analyzer and information dimension dictionary

(76) Inventor: Paul Senn, Swampscott, MA (US)

Correspondence Address: JACK SHORE, MUCH SHELIST FREED DENENBERG AMENT&RUBENSTEIN,PC, 191 N. WACKER DRIVE, SUITE 1800, CHICAGO, IL, 60606-1615, US

(21) Appl. No.: 10/307,589

(22) Filed: Dec. 2, 2002

Related U.S. Application Data
(62) Division of application No. 09/547,291, filed on Apr. 11, 2000.
(60) Provisional application No. 60/128,730, filed on Apr. 12, 1999.

(51) Int. Cl. G06F 7/00

(52) U.S. Cl. 707/3

(57) ABSTRACT

The purpose of the invention described below is to make the information available via the Internet (broadly defined to include intranets and extranets) more useful for applications which need to distinguish not only the factual content, but also other dimensions of information content. One example of a type of information content which is not factual is emotional content Current search engines allow for keyword searches, but it is quite cumbersome to use these engines to pick out sites with specific emotional tones. For-instance, suppose one wanted to use a currently existing search engine to pick out all of the English language internet sites containing predominantly negative references to Microsoft corporation. The English language is complex enough that the task of forming the right keyword and phrase list is formidable. Simply looking for adjectives like “bad” or “disappointing” or “frustrating”, etc combined with the keyword Microsoft will yield thousands of false matches. Such a search would also miss many overall negative sites because the methods of expressing negativity in the English language are so varied.

### BACKGROUND OF THE INVENTION

The present invention is directed to a search engine for searching the Internet, or like networks, for a specific dimension, such as emotional content, which is not available using current, conventional search engines. The problem is not specific to Microsoft, the English language or negative references. The problem exists any time a desire to scope searches based on emotional tone is present, in any language. This invention provides a general solution to this problem by insulating the user from the complex algorithms required to come up with a reasonable set of matches for a search of this type. The user enters the specific keywords for the domain he is interested in (Microsoft, Rugby, flying, whatever it may be) and then picks the “information dimension” he is interested in. An example of an information dimension would be a specific emotional tone (happy, angry, tired, sad, etc).

### SUMMARY OF THE INVENTION

The search engine and system of the present invention will perform a series of searches (one or more) using Content Retrieval Objects (CROs) described below to form the correct search keys. The system will then make use of Content Analysis objects (CAOs) to determine which search results contain the tone of interest and the strength of the tone in each result. CAOs may arrive at their determination using a variety of means. One method used by CAOs could be the comparison of the search results with a repository of audio, visual or text patterns which are relevant to the Information Dimension of interest. This document will describe a version of such a repository which is an extension of a standard dictionary, and which we will refer to as the Information Dimension Dictionary. The CAOs do not return simply yes or no answers to the question of which sites match the criteria, but instead return a summary of search results including a rating, a reference count and a confidence level. The rating describes the level of, for-instance positive emotional tone for a given site or sites and the reference count gives the number of sites the rating is based on. The confidence level describes the level of confidence in the rating.

Another element which can be measured by CAO's is the contrast index. The contrast index describes the difference in strength and direction of emotional tone between two chosen information domains in a given information dimension. For-instance, Sun Corporation is a large competitor to Microsoft Corporation, so one might be interested in the contrast between the reference index for Sun and the reference index for Microsoft within the information dimension of positive emotional tone.

The examples described hereinbelow will focus on the use of the invention to make it possible to effectively search for emotional tones. However, CAOs could be created for any information dimension of interest (for instance a CAO could be created and plugged into the system which determines “speed content”, i.e. whether references to a specific item are predominantly fast or slow).

The Web-based Information Content Analyzer (WICA) consists of two subsystems: a Content Retrieval Engine (CRE) and a Content Analysis Engine (CAE). The CRE formulates the search keys needed to look for a particular information dimension in a particular information domain. The CAE analyzes the search results and makes judgements as to the strength of the search results in a particular information dimension. An example of an information dimension is Emotional Tone (positive vs. negative). An example of an information domain is Microsoft Corporation. The CRE uses Content Retrieval Objects to formulate the needed search keys. There is one or more Content Retrieval Objects (CROs) for each information dimension. So in our example, the WICA would send a message to the correct CRO (the one which knows how to perform text based searches on a given information dimension)) requesting a search for positive references to Microsoft Corporation.

One possible algorithm which the CRO could use to do its job would be to retrieve all pages with references to “Microsoft” and then search these results to extract only those pages which contain words with “positive” emotional connotations. However, note that this invention is not limited to use of text-based search algorithms. Although not very relevant for this specific example, CROs could also be implemented which formulated “search keys” which are digitized images, animation clips, digitized audio, or any other media format supported on the Web.

Returning to our example, after the CRO has retrieved the control parameters it needs to guide its search, it performs the search of the Internet (or extranet or intranet) and produces a list of sites which contain the word Microsoft and at least one word with positive emotional connotations. This list is then handed to the CAE to determine the strength of each hit in the information dimension of emotional tone. The search results are analyzed to determine a reference count, a rating and a confidence level. The algorithm to do this for a given information dimension is contained in a Content Analysis Object (CAO). Possible algorithms used by some sample CAOs are presented here. These are only samples. The invention is designed so that CAOs for new dimensions can easily be added by the user of the system. For-instance, consider the CAO which checks for positive emotional tone in English sentences. Continuing our previous example, after the CRO completes its search, the system sends the search results along with a statement of the Information Domain we are interested in (i.e. Microsoft) to the content Analysis Engine, which invokes the CAO which measures Emotional Tone. In order to accomplish this measurement, the CAO might first analyze the syntax of the sentence to determine which adjectives apply to which nouns, etc. This can be accomplished by an English language syntax analyzer, which returns sentences parsed into a tree structure which can be traversed by the software. Then, for each adjective or adverb which is modifying a noun or verb in the Information Domain of Interest, the CAO must determine whether the result is a positive or negative reference, and the strength of the reference. This can be done by looking up the adjective/adverb in an Information Dimension Dictionary, a computerized dictionary which has been modified to handle this information dimension. The dictionary can include both words and phrases, and would include for each entry, a rating indicating the positive or negative “strength” of the word or phrase (higher is more positive, lower is more negative). For-instance “stellar performance” would have a high rating for the information dimension of Emotional Tone (positive or negative) The Composite Rating represents a combination of the number of positive words found which modify “Microsoft” and the “strength” of each word in this dimension.

An algorithm like the one described here will not return perfectly accurate results in all cases. This is why a confidence level is returned by the CAO along with its conclusion. The confidence level is a statistical concept. For example a site which only contains three weakly positive adjectives to Microsoft may or may not actually be a positive site, while a site with over 100 strongly positive adjectives which modify Microsoft is more likely to be a truly positive site. Another feature which takes this imperfection into account is the ability of the system to route CAO results to an Ambiguity Queue. An Ambiguity Queue is a work queue which the WICA can send search results to for further analysis and special processing. Entries in the Ambiguity Queue could be read by another application which approach the analysis in a different way and returns modified rating, reference count and confidence level to the WICA. One approach which could be taken would be to have the Ambiguity Queue serviced by a human being, who looks at the search results and enters a rating and confidence level manually. Analysis done for entries in the Ambiguity Queue would be fed back to the system in the form of both enhancements to the CAOs and additions to the repositories used by the CAOs. For-instance, one reason a reference might be sent to the ambiguity Queue is that a particular adjective or adverb did not have an entry in the Information Dimension Dictionary for that dimension. The analysis done by the application or person serving the Ambiguity Queue could result in an addition of new data to the Information Dimension Dictionary, or the changing of data in the dictionary.

As with standard search engines, the output of the WICA would be a list of search results which meet the criteria specified by the user. The search results could be sorted by rating, confidence level, reference number or a combination of these things. In our example, the user could thereby receive a list of sites containing positive references to Microsoft, sorted by the Composite Rating (strength of the positive tone). The list could also contain a contrast index for each site, indicating the difference between the Composite Rating for Microsoft and the Composite Rating for selected Contrast Domains. The contrast index would also contain a confidence level. The list obtained using this invention would be much more valuable and targeted to the user's real needs than a list obtained using conventional search engine techniques.

### BRIEF DESCRIPTION OF THE DRAWING

The invention will be more readily understood with reference to the accompanying drawing, wherein:

The FIG. 1 is a schematic showing the major components of the system of the invention;

FIG. 2 is a flowchart of the Content Retrieval Objects (CRO);

FIG. 3 is a flowchart of the establishment of the population of the Information Dimension Dictionary;

FIG. 4 is a flowchart of the Content Analysis Engine (CAE);

FIG. 5 is a flowchart of the Load Ratable Search Results Function; and

FIG. 6 is a flowchart of the Default Rate Method of Class Ratable Units.

### DETAILED DESCRIPTION OF THE INVENTION

The search invention of the invention is preferably used for the Internet 10, in the figure, to which are operatively coupled Web Sites 12, a system-administrator browser 16, an end-user browser 18, a WICA 20 (Web-Based Information Content Analyzer) described hereinbelow, and a WICA database 22, also described hereinbelow. The following describes the content of the WICA Site 20 and the WICA database.

“Content Retrieval Objects”

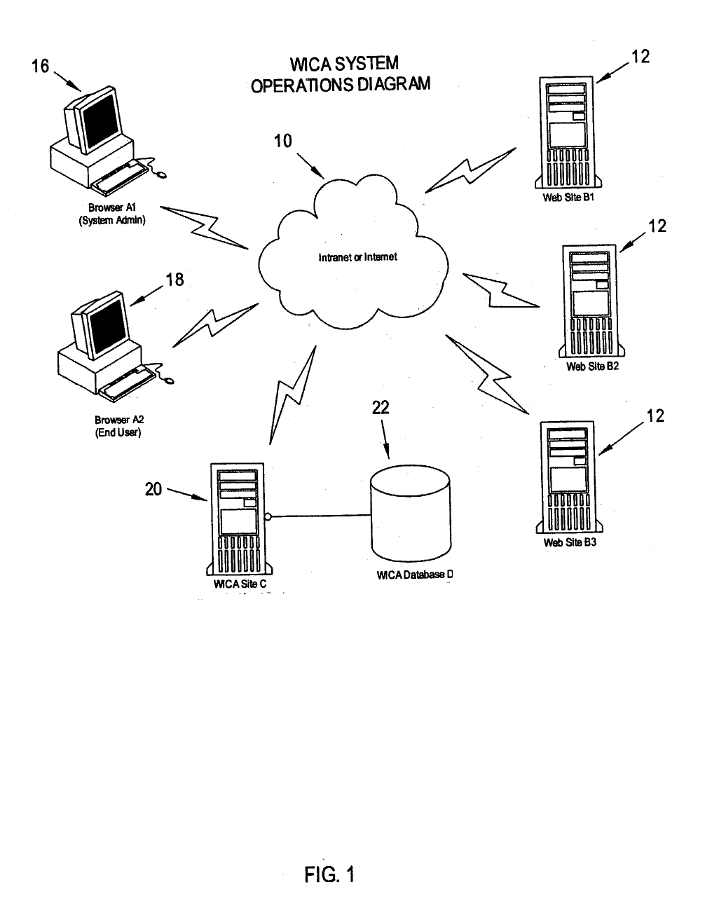

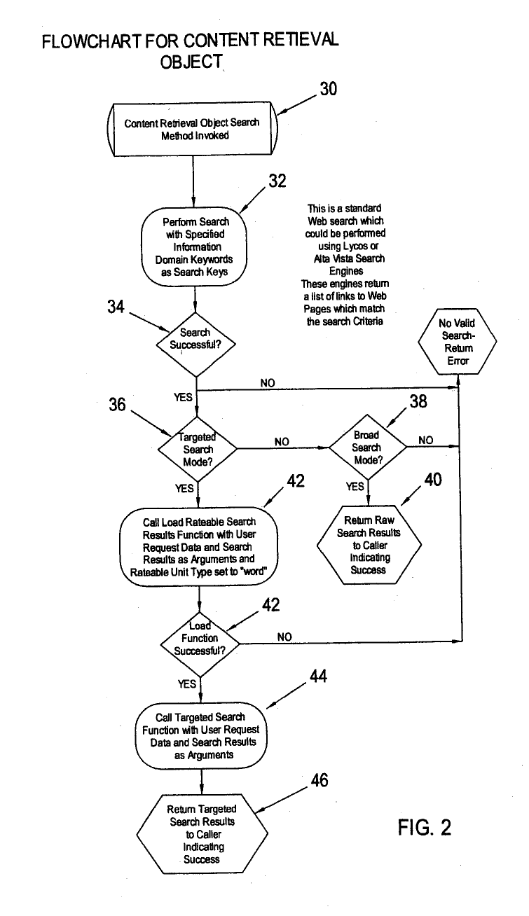

Referring to FIG. 2, the role of the Content Retrieval Object (CRO) is to create Search Results that can be passed on to the Content Analysis Engine (CAE), which will determine a Rating for the results in the Information Dimension and Information Domain of interest (Blocks 30-34). The CRO can operate in two modes: Broad Search Mode and Targeted Search Mode (Blocks 36, 38). In Broad Search Mode, the CRO takes the keywords chosen by the user which define the Information Domain, and simply performs a search using those keywords. The Search Results are then directly passed on to the CAE. Broad Search Mode simply performs a search in the same manner as the common search engines (such as AltaVista), in operation today (Block 40). Targeted Search Mode (Blocks 42-46), however, is a unique feature of this invention, which we shall now describe.

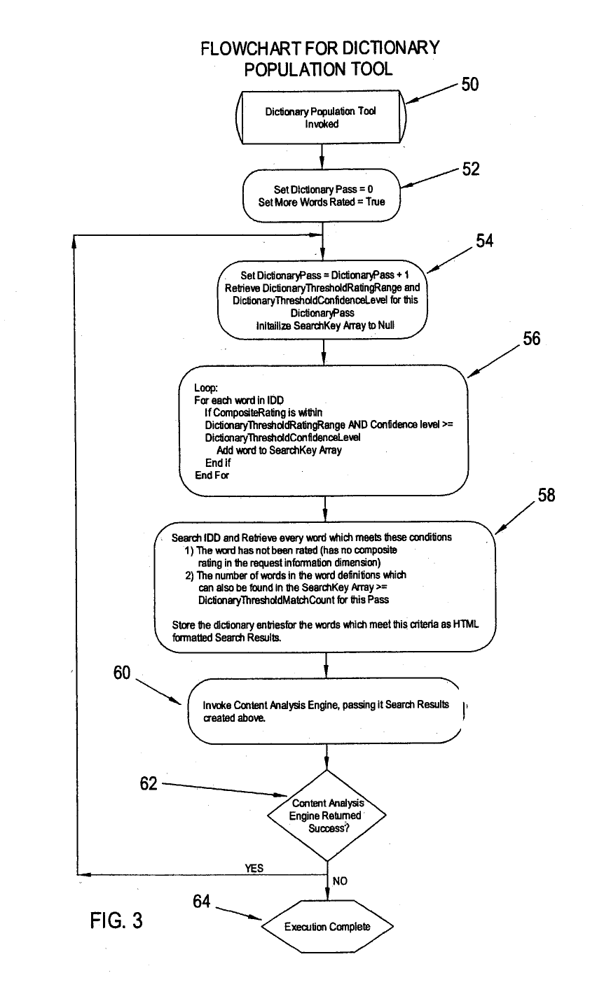

Targeted Search Mode requires setup of an Information Dimension Dictionary (FIG. 3. An Information Dimension Dictionary is a standard dictionary enhanced to support the needs of of the CRO and CAE. In the discussion below, the objects used to enhance the dictionary (and in fact all objects referred to in this document) are described using the syntax of the Java Programming Language. The syntax used is Java with the addition of “Collection”, which simply refers to a collection of objects of a given type. It could also be thought of as an array of objects. The term “Collection” is further discussed in conjunction with PL/SQL in the attached description of PL/SQL from Oracle Corporation. Also the term “Method” is used in the class definitions which simply indicates that the class would contain a Method to do a certain function. “String” is used as a data type to denote an arbitrary length text string. The Class definitions below are not intended to be the complete definition which would be used in a production system, but to provide enough detail so that a skilled Java programmer could implement the class with the intended results.

To illustrate the contents and usage of this dictionary, let us take as an example of a standard, online dictionary, the Merriam Webster's Collegiate Dictionary, Electronic Edition, (version 1.2, 1994). This dictionary has the following fields:

1) word, the word being defined

2) pronunciation

3) function (noun, pronoun, etc)

4) etymology

5) date

6) a numbered list of definitions: (with letters for sub-categorizations of definitions eg. 1a, 1b, 1c, 2a, 2b . . . , etc).

A word in this dictionary is an example of a “Ratable Unit”. A Ratable Unit is anything (words, images, sentences, links, etc) which can be given a rating in an Information Dimension. To implement the Information Dimension Dictionary, the Webster's dictionary is enhanced in two ways: The end user can add entries to the dictionary (such as phrases or proper nouns), and the list of definitions (number 6 above) for any given word is enhanced to support tagging each definition with a rating and confidence level in one or more information dimensions. To implement this feature, each definition in the list for a given word is tagged with a Collection of DefinitionRatingandFrequency Objects. A DefinitionRatingandFrequency Object has the following form:

Class DefinitionRatingandFrequency {

String InformationDimension;

Int Rating; /*specifies a rating for a definition within this InformationDimension*/

Float Confidence Level; /*Confidence Level in the Rating */

Float Frequency; /* percentage of the time this definition is the intended one in common language usage */ }

The data elements declared in the Definition RatingandFrequency object can also be described as a set using a shorthand notation of (Name-value1-value2-value3), a syntax which we will also make us of in this document. The data elements, listed in the order of their declaration, so Name is the information dimension of interest, value1 is the rating of the definition in that information dimension, and value2 is the confidence level in the rating, and value3 is a measure of the frequency of that definition in common usage relative to other possible definitions. This set notation will sometimes be used in this document to refer to the data elements in objects.

Ratable Units can be composed of other Ratable Units (For-instance, a Paragraph contains Sentences), creating a hierarchy of Ratable Units. The term “Composite Rating” is used to represent a summary rating which takes into account this hierarchy. For-instance, the Composite Rating for a Paragraph is a roll-up of the ratings of the Sentences within the Paragraph. A word whose definitions are tagged with a collection of DefinitionRatingandFrequency objects also has a Collection of CompositeRating Objects, which summarizes the overall rating for the word in the Information dimensions of interest. The CompositeRating Object has a similar form to the DefinitionRatingandFrequency Object:. The classes listed below and the meaning and usage of the data elements and rating methods are described in more detail below, but are simply introduced here.

Class CompositeRating {

String InformationDimension

Int Rating

Int ReferenceCount (number of Ratable Units the CompositeRating is based on)

Float Confidence Level

}

Class Ratable Unit ( /*Virtual prototype class on which all Ratable Units are based*/

Link SourceURL /*This is an HTML link, which identifies the URL of the page the RatableUnit came from *./

String RatableUnitType; /'*identifies Type of Ratable Unit*/

String Description;

Int RatableUnitHierarchyLevel; /* RatableUnits can contain other RatableUnits. However, a Ratable Unit can only contain other items which have a lower RatableUnitHierarchyLevel. The rating algorithm can use this hierarchy to drive the order in which to determine Ratings */

Collection (CompositeRating);

Method Rate /* This is the default Rating method for all Ratable Units. It can be overridden simply by defining a Method called Rate within a specific RatableUnit.

)

Class Definition (

String Word; /* (Word being defined) */

String DefinitionFunction; /* (noun, pronoun, etc) */

/* The data items below refer to Classes Subject, Object and Predicate. The intent is to represent the dictionary definitions as sentences, parsed into their component parts. It is assumed that each definition consists of one sentence. It is recognized that dictionary definitions are not well-formed sentences, but the categories below are still useful in rating the definition. */

Subject DefinitionSubject; /*

Object DefinitionObject;

Predicate DefinitionPredicate;

Collection (DefinitionRatingandFrequency);

Method Rate;

)

Class Word extends Ratable Unit (

String Word;

Collection (Definition);

Method Rate

)

Note that the Word class “extends” RatableUnit. This is the Java version of inheritance, and it means that the Word class inherits all of the data items and Methods defined for the RatableUnit class. So, for-instance, the Word class contains a collection of CompositeRating objects. It is a collection rather than only one because the system can support multiple information dimensions, and there may be many different information dimensions each with a separate rating for this word. If a word has only one definition, the Composite Rating for the word in a given information dimension will be identical to the rating in the DefinitionRatingandFrequency object for that definition. If the word has multiple definitions, the Composite Rating will summarize the rating for the word given the multiple definitions, and the confidence level in that rating.

The system as a whole can be thought of as working from four different data stores. These are:

1) A Raw Search Results data store. This data store contains the search results returned by the search engine. These results take the form of HTML pages comprised of lists of links, sometimes with a short abstract from the page the link points to (like the first n characters of text).

2) A Ratable Search Results data store. Words in the Search Results are looked up in the Information Dimension Dictionary, and stored in the Ratable Search Results data store along with their rating in the information dimension of interest. For Ratable Units higher in the hierarchy then words (such as Sentences), a natural language parser analyzes the syntax of the search results, and puts the parsed representation into the Ratable Search Results data store. This data store can take the form of an Oracle database, with relational tables and constructs which mirror the RatableUnit Class definitions described above.

3) A Control Table data store. This consists of a set of relational tables which contain parameters and configuration data. These tables can also reside in an Oracle database.

4) An Information Dimension Dictionary. This is a dictionary which has been extended to include ratings.

The method for determining CompositeRating in this case, and for population of the Information Dimension Dictionary is described in a separate section below. Let us for now assume the dictionary is populated with Composite Ratings for a large group of words for a given Information Dimension, and describe how this dictionary is used in Targeted Search Mode.

In Targeted Search Mode, the user can enter a Threshold Rating Range, and a Threshold Match Count. For a page to meet the search criteria, it must include at least as many words as the value of Threshold Match Count which fall within the Threshold Rating Range. For example let us assume a rating scale of −100 to 100 and let us assume we are concerned with the information dimension of Emotional Tone. Let us assume the higher the rating, the more positive the emotional tone is. A user could specify a Threshold Rating Range with a lower bound of 70 and an upper bound of 100, and a Threshold Match Count of 20. Then, for a page to meet the search criteria, it must contain at least 20 words with Ratings for emotional tone of between 70 and 100 With this approach, the number of matches found by the Search becomes more significant input to the Content Analysis Engine then in Broad Search Mode, where the number of matches does not contain any measurement against the information dimension of interest.

Search Results in both Broad Search Mode and Targeted Search Mode are communicated to the CAE in the SearchResults object. An example of a SearchResults object is:

Class SearchResult {

string SearchResultId; /*Unique identifier for this search −populated by CRO */

string ContentRetrievalObjectID; /*Identifier of the type of the Content Retrieval Object which performed the search.*/

String InformationDimensionDictionaryPath; /*identifies the location of the Information Dimension Dictionary used in the search */

string SearchResultMode; /* Broad or Targeted—populated by CRO*/

string SearchCriteria; /*string defining exactly what the search criteria were (keywords, etc)—populated by CRO*/

string SearchDateTime; /*Time and date the search was performed—populated by CRO */

string SearchResultURL; /*URL indicating where result of search was stored—populated by CRO*/

string TotalMatches; /*Total number of search results returned—populated by CRO*/

Collection (CompositeRatings); /* populated by CAE. The composite rating stored here is the rollup of the analysis of the entire results set returned by this search.*/

}

An example of an algorithm for the Content Retrieval Object in Targeted Search Mode can then be summarized as follows:

1) Retrieve initialization data. This includes retrieving the Information Dimensions of interest, user-chosen search keys which define the Information Domain, the choice of where to perform the search (internet, intranet, etc) and the user-chosen threshold rating ranges and match counts. (These values can be stored in a standard relational database such as Oracle)

2) Retrieve from the Information Dimension Dictionary all words which have Composite Ratings which fall within the threshold rating range in the information dimension of interest.

3) Perform the search of the chosen Internet or intranet and analyze the results using the combination of both the words retrieved in step 2 and the user-chosen search keys which define the information domain. A page matches the search criteria and is included in the search results set if and only if it contains at least one of the user-chosen search keys AND it contains at least as many words as specified by Threshold Match Count which fall within the Threshold Rating Range

4) Generate a Search Results object which captures the search results and makes them available to the CAE.

This is only an example of a Content Retrieval Object. The system is designed in a manner such that new Content Retrieval objects can be created, perhaps to support image retrieval criteria or audio file retrieval criteria. These search results can be made available to the CAE via a SearchResults object like the one defined above.

For the algorithm described above to work, the Information Dimension Dictionary must be populated. The next section describes how this occurs.

“Population of the Information Dimension Dictionary”

The invention describes a unique way for using a relatively small Core Group to automatically generate ratings in the Information Dimension Dictionary for a very large group of words. Because of this automatic process, it is practical for a domain expert in the information dimension of interest to manually generate ratings for a small group of words (called the Core Group), and propagate these ratings to cover a large group of words and phrases. The process starts by populating the Core Group with ratings, confidence levels and frequency measures. To illustrate a process for creation of a core group, we will use Microsoft Corporation as our sample Information Domain and positive emotional tone as our sample Information Dimension. Let us suppose we have at our disposal a computer which has stored on disk 10,000 articles about Microsoft Corporation. Note we could also have used as our starting point the results of an Internet search for references to Microsoft. The initial source of the data is irrelevant. The basic process we follow to create a Core Group is as follows (reference is had to Blocks 5064 of FIG. 3):

1. Find all sentences in the data containing references to Microsoft

2. Parse the sentence structure and find all adjectives, adverbs or phrases which modify Microsoft.

3. Extract a small (but statistically significant) number of references for each unique adjective, adverb or phrase.

4. Analyze the reduced sample taken in step 3 and produce a rating for each unique adjective, adverb or phrase for the particular information dimension of interest.

5. Load the resulting words, phrases and associated ratings into the dictionary. This is the Core Group for the Information Domain Microsoft /Information Dimension positive emotional tone.

After the core group has been created, a search is performed on the dictionary itself for words which have not yet been rated, but could be rated because they include words from their Core Group in their definitions. We shall call this initial search Dictionary Search Pass 1. For this search, the administrator of the system can set up a Dictionary Threshold Rating Range, a Dictionary Threshold Match Count, and a Dictionary Threshold Confidence Level which have analogous meanings to the parameters described above with similar names. That is, the dictionary search will only use as search keys words which have ratings in the Threshold Rating Range, and Confidence Levels at least as high as Dictionary Threshold Confidence Level. Also, for a word to meet the search criteria, it must include in its list of definitions at least as many of the search keywords as the value of Dictionary Threshold Match Count. The search results consist of a group of words which do not yet have ratings, but which contain in their definitions words which do have ratings. These search results are sent to the Content Analysis Engine (CAE).

The CAE is described in a separate section below, For now, let us just assume that the CAE will give the new set of words ratings. After the CAE has done its work, the process of doing the dictionary search can be repeated, using as search keys, the new, larger set of words which have ratings. For this next pass (Dictionary Search Pass 2) the user can select a different Dictionary Threshold Rating Range, Dictionary Threshold Match Count and Dictionary Threshold Confidence Level than that used in Dictionary Search Pass 1 if desired. Note that the search will only return in the search result words which have not yet been rated. After this pass completes, the new results are sent to the CAE for rating. The automatic process continues iteratively until no more search results are returned by a Dictionary Search Pass. At this point all the words in the dictionary which can be rated have been rated (given the user specified parameters).

The user parameters for Dictionary Threshold Match Count, Dictionary Threshold Rating Range and Dictionary Threshold Confidence Level can be entered and stored in a database in a manner which will indicate to the system which parameters to use for a given pass. A table can be created (using standard database technology) which contains an entry for the dictionary pass number and its associated values. A sample representation with some sample data might be the following table:

| | | | Dictionary | | Dictionary |
|---|---|---|---|---|---|
| Dictionary | | Dictionary | Threshold | | Threshold |
| Search | Information | Threshold | Rating | | Confidence |
| Pass Key | Dimension | Match Count | Range | | Level |
| Pass1 | Emotional | 2 | Low: | 80 | .90 |
| | Tone | | High: | 100 | |
| Pass2 | Emotional | 4 | Low: | 80 | .90 |
| | Tone | | High: | 100 | |
| >=Pass3 | Emotional | 5 | Low: | 70 | .80 |
| | Tone | | High: | 100 | |

The third entry illustrates the concept that a single row can specify the values for multiple passes. This entry specifies that for all Dictionary Search Passes starting with Pass 3, use a Dictionary Threshold Match Count of 5, a Dictionary Threshold Rating Range of between 70 and 100, and a Dictionary Threshold Confidence Level of 0.80

Referring again to FIG. 3, the algorithm for populating the Information Dimension Dictionary can then be summarized as follows: The algorithm assumes that a Core Group of words have been tagged manually or through some other process (i.e. that the number of words with ratings at the start of the process is non-zero).

1) Retrieve initialization data. This includes retrieving the Information Dimensions of interest, a path to the dictionary which is desired to be populated, and the user specified Dictionary Threshold, Match Count and Confidence Level parameters described above. Initialize the Dictionary Search Pass value to 0.

2) Increment the Dictionary Search Pass value. Search the Information Dimension Dictionary for all words which have Composite Ratings and Confidence levels which match the user-specified criteria for the current Dictionary Search Pass. This search will yield a collection of words which will be used as search keys in step 3.

3) Perform a search on the Information Dimension Dictionary using the results from step 2 as search keys. Only include in the search result words which have not yet been rated and have at least as many of the search key words in their definition as the number specified in Dictionary Threshold Match Count for the current Dictionary Search Pass. Generate a Search Results object which captures these results. (This search will yield a collection of words which can be rated because they include in their definition words which have already been rated.)

4) If the number of search results obtained in step 3 is non-zero, pass these search results to the Content Analysis Engine for Rating. (After the Content Analysis Engine completes successfully, a new group of words will have ratings in the Information Dimension Dictionary).

5) Repeat steps 2-4 until there are no more search results generated in step 3. At this point the process is complete.

“Content Analysis Engine”

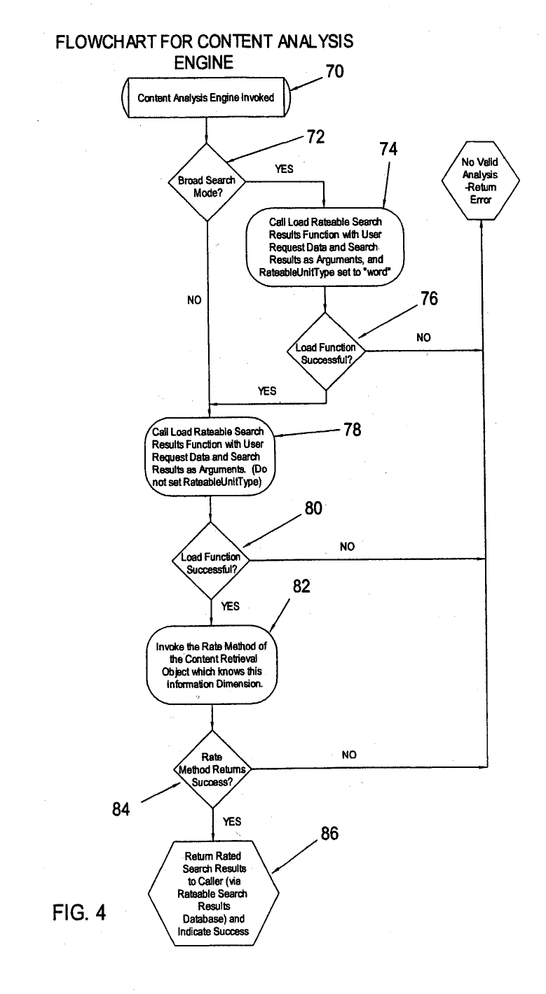

Referring to FIGS. 4, the Content Analysis Engine (CAE) is used to give Ratings to Ratable Units within Information Dimensions. A Ratable Unit can be for-instance, a word, a phrase, a sentence, a paragraph, a document, an Image, an audio file, etc. The CAE takes as input Search Results containing Ratable Units, and provides as output the same search results with ratings given to the Ratable Units. The work of the Content Analysis Engine is done by Content Analysis Objects. Since the dictionary population algorithm is fresh in the readers mind, having been described above, let us start by describing an algorithm which could be used by a Content Analysis Object to rate words. It will be seen that the algorithm used to rate words can also be applied to larger Ratable Units such as sentences, paragraphs, etc., and can ultimately be used to produce an overall rating and confidence level for a given search.

Let us take as an example the information dimension of Emotional Tone. Some words have an obvious positive or negative emotional connotation, while others are neutral. The emotional tone being conveyed by other words depends on the context in which the word is being used. For example if we look up “horrendous” in the Webster's dictionary mentioned above, we find it has only one definition ('perfectly horrid”). Assuming a scale of −100 to 100, where −100 is as the most negative emotional tone, and 100 is the most positive emotional tone, “horrendous” can safely be given a very negative rating (like −100), with a high confidence level (like 0.90 assuming a scale of 0 to 1 for confidence level) since there is only one definition. Since there is only one definition the probability of this being the intended definition is 1.0 (on a scale of 0 to 1). So in this case there would be only one DefintionRating object for Horrendous in the Information Dimension Dictionary. The DefinitionRating object would contain the values: (EmotionalTone, −100, 0.90, 1.0). Anything which is described as “horrendous” is being described in a negative manner. The adjective “stubborn” on the other hand, can either mean “unreasonably or perversely unyielding” (definition 1a), or justifiably unyielding (definition 1b), This illustrates the fact that not everything being described as “stubborn” is being described in a negative manner. Definition 1a of “:stubborn” might be given a rating of −75 with a confidence level of 0.90, while definition 1b might be given a rating of +75, with a confidence level of 0.90. The word “stubborn” would have 2 DefinitionRating Objects. Let us suppose that either through quantitative analysis or based on the opinion of a domain expert, it is determined that in modern English usage, definition 1a of “stubborn (“unreasonably or perversely unyielding”) is the intended meaning of the word 70% of the time it is used, while definition 1b is the intended definition 30% of the time. So the DefinitionRating object for 1a would be (EmotionalTone −75, 0.90, 0.70) and the DefinitionRating object for lb would be (EmotionalTone, 75, 0.90, 0.30). So what should the Composite Rating be for the word “stubborn”?

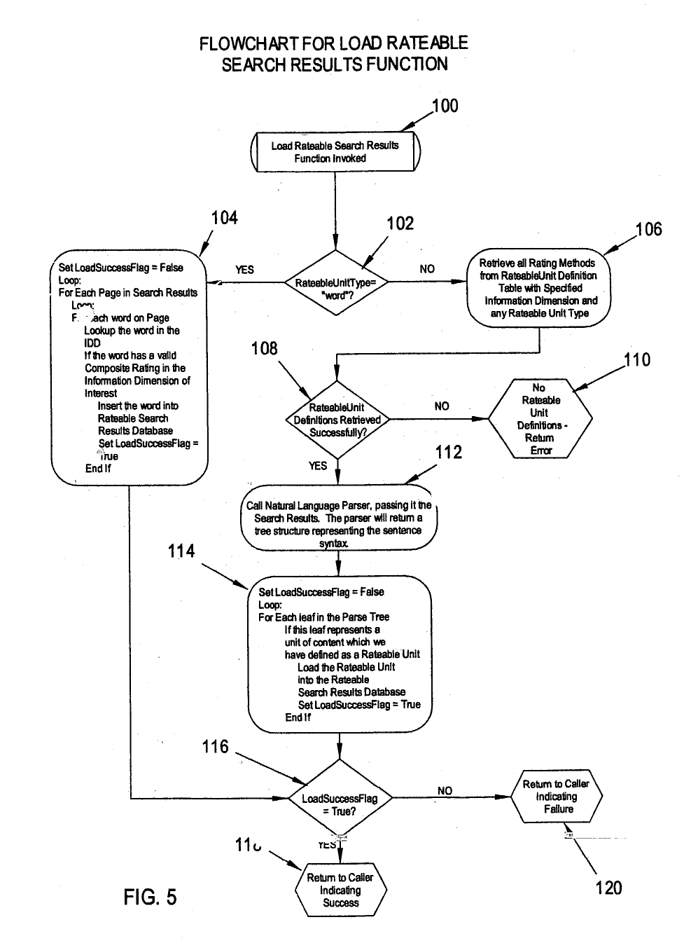

One way the Composite Rating can be determined is by treating the confidence levels and frequency values in the DefintionRating object as probabilities, and then making use of the basic rules for calculating probabilities. That is, the probability that definition 1a is the intended definition in a given sentence is 70%. This is independent of the probability that −75 is an accurate rating for definition 1a, which is 90%. The rules of probability state that for two independent events, the probability of (Event P AND event A) occurring is equal to (Probability of Event A) multiplied by (Probability of Event B). 0.90×0.70=0.63. So the entry relating to Emotional Tone in the collection of CompositeRating Objects for “stubborn” would be: (Emotional Tone, −75, 0.63). Recall that the first data item in the Composite Rating object is the information dimension of interest, the 2^{nd} data item is the rating in that dimension and the third data item is the confidence level in the rating. The third entry, 0.63 is the product of 0.90 (the confidence level in the rating for definition 1a, the most likely meaning) and 0.70 (the confidence level that indeed 1a is the intended meaning) The algorithm for providing Composite Ratings to words can then be summarized as follows (reference is had to Blocks 70-86 of FIG. 4 and Blocks 100-120 of FIG. 5):

1) Retrieve the collection of Definitions and DefinitionRatingandFrequency Objects for the word

2) For each DefinitionRatingandFrequency object, Multiply the Confidence Level by the Frequency, and consider the result to be the probability that the word will have that particular definition.

3) Take the definition rating with the highest probability obtained in step 2, and use its Rating as the CompositeRating. Use the probability obtained in step 2 as the confidence level in the Composite Rating.

Given this method of rating words, how are sentences rated? A sentence is more than just a collection of words, and the grammatical structure of a sentence must be taken into account to rate the sentence effectively. Fortunately, a significant amount of research has gone into the area of machine parsing of natural language, and parsers are now available commercially which analyze text and create a tree structure representing the grammatical structure of a sentence. An example of such a parser is the one available from Conexyor Corporation. These parsers are far from perfect, but are improving every day as more research goes into this area. The approach taken for this invention is to create objects which represent grammatical structures, and use a third-party parser to populate these structures, As parsers improve, this approach allows the invention to make use of the new innovations without changing the basic structure of the system. A new improved parser can be swapped in which simply populates the grammatical structure objects (defined below) more reliably and in more cases than an older generation parser without disturbing the basic framework of this invention. The current generation of parsers can identify the basic constructs of English language syntax fairly well, those constructs being Subject, Object, Predicate and Modifiers. These are the grammatical objects which are used in the examples below.

A unique feature of this system related to this discussion is the manner in which links to Internet sites are analyzed. A link is considered an extension of language grammar. So to capture the basic meaning of a sentence the system should identify and tag not only the Subject, Object, Predicate, and Modifiers but also the Links which make up the sentence. Subject, Object, Predicate, Modifiers and Links are all examples of Rateable Units. Methods can be defined for assigning composite ratings for each of these Ratable Units. The system is designed to allow the user not only to define new Ratable Unit objects, but to define methods for assigning Composite Ratings to these objects. As we described above, each RatableUnit object has a CompositeRating as well as a collection of objects which make up the Ratable Unit. For-example, a word is a Ratable Unit. The Word contains a collection of Definition objects. A Subject contains a collection of Word objects, as does an Object (here meaning a grammatical structure “object”, not a Java Object), a Predicate and a Modifier. A sentence contains Subject, Object, Predicate, Modifier and Link Objects. A Paragraph contains Sentence Objects. A Page (as in a Web Page) can contain not only Sentence Objects, but other types of Ratable Units such as Image objects, audio file objects, animation objects, etc. A Search Result Object contains a collection of Pages. The user can define methods for assigning Composite Ratings to all of these structures (as well as define new structures), which is one of the unique features of this invention, The process described is very flexible because it does not hard-wire definitions of what can be rated. The idea is that the user of the system can define RatableUnits, define the Relationships between Ratable Units, and define Methods for determining ratings in a given information dimension. An example of the Java Classes which could be written to implement this scheme follows. Note that the principle of inheritance is used to define a base class called RatableUnit, which contains a default rating Method plus the data elements common to all Ratable Units. Other types of Ratable Units extend (the Java term for “inherit from”) the RatableUnit class. The class descriptions below illustrate these concepts. The RatableUnit class definition was already given above, but is repeated here with additional comments relevant to this discussion.

Class Ratable Unit ( /*Virtual prototype class on which all Ratable Units are based*/

Link SourceURL /*This is an HTML link, which identifies the URL of the page the RatableUnit came from *./

String RatableUnitType; /'*identifies Type of Ratable Unit*/

String Description;

Int RatableUnitHierarchyLevel; /* RatableUnits can contain other RatableUnits. However, a Ratable Unit can only contain other items which have a lower RatableUnitHierarchyLevel. The rating algorithm can use this hierarchy to drive the order in which to determine Ratings */

Collection (CompositeRating)

Method Rate (

/* This is the default Rating method for all Ratable Units. It can be overridden simply by defining a Method called Rate within a specific RatableUnit. This default method allows the user to specify the technique for rating simply by populating entries in the RatingMethod Table for various types of RatableUnits Steps in the algorithm are:

1. Use the Type as the key, and look in the RatingMethod Table for a Rating Method for this type of RateableUnit

2. If a RatingMethod is not found, return an error,

3. If a RatingMethod is found, apply it. RatingMethod specifies a set of operations to be performed on data elements accessible to the RatableUnit. The table also specifies a set of operations to be performed to determine ConfidenceLevel in the Rating.

)

Class CompositeRating (

String InformationDimension;

Int Rating;

Int ReferenceCount; /* (number of RatableUnits the CompositeRating is based on)*/

Float Confidence Level;

)

Class Definition (

String Word; /* (Word being defined) */

String DefinitionFunction; /* (noun, pronoun, etc) */

/*

The data items below refer to Classes Subject, Object and Predicate. The intent is to represent the dictionary definitions as sentences, parsed into their component parts. It is assumed that each definition consists of one sentence. It is recognized that dictionary definitions are not well-formed sentences, but the categories below are still useful in rating the definition. */

Subject DefinitionSubject; /*

Object DefinitionObject;

Predicate DefinitionPredicate;

Collection (DefinitionRatingandFrequency);

Method Rate;

)

Class Word extends Ratable Unit (

String Word;

Collection (Definition);

Method Rate;

)

Class Modifier extends RatableUnit (

Collection (Word);

Method Rate;

)

Class Subject extends RatableUnit

String SubjectText;

Collection (Modifier);

Method Rate;

)

Class Object extends RatableUnit (

String ObjectText;

Collection (Modifier);

Method Rate;

)

Class Modifier extends RatableUnit (

Collection (Word);

Method (Rate);

)

Class Sentence extends RatableUnit (

Subject SentenceSubject;

Object SentenceObject

Predicate SentencePredicate;

Method Rate;

)

Class Link extends RatableUnit (

URL URLtext;

)

Class Paragraph extends RatableUnit (

Collection (Sentence);

)

Class Page extends RatableUnit (

Text URL;

Collection (Paragraph);

Collection, (Link);

Collection (Image);

Collection (Movie);

Collection (Sound);

Collection (Scent);

Collection (Animation);

Method Rate;

)

Public Class SearchResult extends RatableUnit (

Collection(Page);

Method Rate;

)

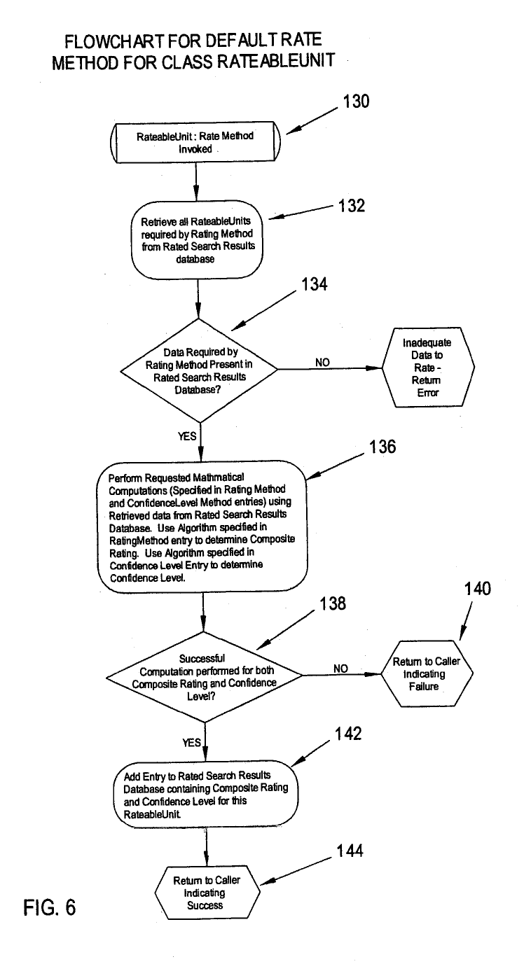

In order to define a new Ratable Unit type, the user simply creates a new class which extends RatableUnit. He can then either create his own Rating Method or use the default defined for the class (FIG. 6, Blocks 130-144). The default Rate Method utilizes the Rating Methods table. Using this table, the user can choose from a set of mathematical functions, and apply one or more of these functions to the data elements available in the RatableUnit object. Examples of mathematical functions which could be available to the user are:

Mean

Median

Mode

Product

Dividend

Sum

Square Root.

The following table illustrates some examples of the technique which the user can take advantage of to define Rating Methods for the above Ratable Units.

“RatableUnit Definition Table”

| Ratable | | | |
|---|---|---|---|
| Unit | Information | | |
| Type | Dimension | RatingMethod | ConfidenceLevel Meth [symbol] |
| Sentence | Emotional | Median(Subject.CompositeRating.Rating, | Product (Subject.Comp [symbol] |
| | Tone | | onfidence Level, |
| | | Object.CompositeRating.Rating, | Object.CompositeRati [symbol] |
| | | | Level, |
| | | Predicate.CompositeRating.Rating) | Predicate.CompositeR [symbol] |
| | | | nceLevel |
| Paragraph | * | Median(Sentence[*].CompositeRating.Rating) | Product(Sentence[*]. [symbol] |
| | | | ng. ConfidenceLevel) |

Note the use of the asterisk as a wild card in the second entry above, which indicates that the rating method applies to any information dimension. Note also that by using this technique in the algorithm for population of the Information Domain Dictionary, the algorithm for choosing ratings and confidence level for Words can also be table-driven and chosen by the user. This is why the algorithm described in the above section was called an example of a method for population of the dictionary. Again, the flexibility given the user is a key part of the uniqueness of the system.

Since RatableUnits can contain other RatableUnits, a Hierarchy of RatableUnits may exist. For-instance, Words, contain Definitions, Predicates contain Words, Sentences contain Predicates, and Paragraphs contain sentences. This hierarchy is represented by the RatableUnit Hierarchy Level. So Definitions might be at Level 1, Words at Level 2, Predicates at Level 3, Sentences at Level 4 and Paragraphs at Level 5. Because of this table driven approach an automated tool can generate proposed rating methods. The universe of possible entries in the RatingMethod and ConfidenceLevelMethod column in the above table for each Ratable Unit Type is limited and well-defined. Therefore, even a trial and error approach is not impractical, where the tool simply goes through the set of possible entries in a systematic way (see what Rating results from using the Product of data items, median of data items, etc) until a set of methods is generated which match the ratings given the test sample by a human. A unique feature of this invention is it makes it possible for such a tool to generate proposed rating methods iteratively until it comes up with a machine generated rating which matches human wisdom.

The overall process of applying the invention to a specific information dimension and information domain is as follows:

1. Setup and validation Phase

a. Define Core Group of Ratable Units (can be words, phrases, images, URLs, audio files, mpg, etc)

b. Define a Sample Information Domain (i.e. the list of keywords which capture a subject of interest)

c. Determine Ratings and confidence levels for Core Group

d. Set dictionary threshold, match count and confidence level parameters for determining Composite Ratings of words beyond the Core Group (including words with multiple definitions and words whose definition includes Core Group words.)

e. Run automated process to populate Information Dimension Dictionary with ratings based on Core Group and parameters defined above.

f. Choose Ratable Units for this information dimension and create new ones if necessary

g. Create sample Search Results and manually rate these results in this Information Dimension and the Sample Information Domain

h. Either manually generate, or run automated process to generate Rating Methods for all Ratable Units (phrases, sentences paragraphs, pages, links, images, collections of pages, etc) This process will take the sample Search Results created in step f and output the Rating Method table entries for the which yields results which match as closely as possible the composite rating given to the sample Search Results by a domain expert.

i. If the above process does not yield satisfactory results (meaning the automatically generated composite ratings do not match the manual, human-generated ratings closely enough), the following measures can be taken to improve the system performance:

The Core Group can be expanded, and steps a-f repeated with new Core Group as base

The Ratings and confidence levels for the Core Group can be modified and steps c-g repeated with these modified parameters.

The parameters used for determining Composite Ratings of words beyond the Core Group can be modified, and steps d-g repeated with modified parameters

New Ratable Units can be created.

The Automated process for generation of Rating Methods can be overridden with human-provided algorithms and steps f and g repeated.

A unique feature of this system is the ability to revise assumptions at all levels and then automatically test the new assumptions until accurate ratings are obtained.

The above steps are repeated until the system performance against the test samples is adequate. At this point the system is set up with a Core Group of ratings, the dictionary populated with composite ratings for a superset of the Core Group, and accurate Rating Methods have been defined for all Ratable Units.

At this point, searches can be performed which will return meaningful composite ratings for the information dimension of interest. The CRE will perform the search, the CAE will analyze the results, and a SearchResult object will be created containing the Composite Rating for the search. Note that a SearchResult object consists of a collection of pages. These pages could be sorted in descending order by CompositeRating, so that the highest rated pages are listed first. The system thus has utility as a special purpose Search Engine. Note also that the system could do periodic searches (say every 2 hours) on more than one information domain within an information dimension, or on multiple information dimensions for the same domain. An example of the former would be searches on both Sun and Microsoft (as Information Domains) within the Information Dimension of Emotional Tone. Every 3 hours, a CompositeRating would be returned for each of these domains. The Ratio between these two ratings we refer to as the “contrast index”. If the contrast index is defined as CompositeRating for Sun/CompositeRating for Microsoft), then we see that as the number gets smaller, Microsoft is gaining in popularity, and we could track the perception of these companies relative to one another using this index.

Note that the techniques described above are not foolproof, as is evidenced by the need for a confidence level field. It would be nice to have a way for the system to incrementally improve as a result of usage of the system. The desire is to have the system “learn from experience”, to tune the rules and add words to the Core Group or modify the Core Group. The system provides a way to accomplish this via the Ambiguity Queue. For each Ratable Unit type, the user can specify a set of thresholds which will result in the RU being put on the Ambiguity Queue. This is accomplished via the following table:

“Ambiguity Queue Control Table”

| | | Ambiguity Threshold | | |
|---|---|---|---|---|
| RatableUnit | Information | Confidence Level | | Target Am [symbol] |
| Type | Dimension | (range) | | Percentag [symbol] |
| Sentence | Emotional | Low: | .10 | .10 |
| | Tone | High: | .20 | |
| Page | * | Low: | 0 | .20 |
| | | High: | 70 | |

The second entry states that for the RatableUnit Page in any information dimension, put the Page object on the Ambiguity Queue if the Confidence Level in the Composite Rating is between 0 and 0.70 (no higher). The Target Ambiguity Queue Percentage is used during the validation phase of the system setup., as follows. The steps below follow logically after the steps a-f described above.

2. Beta Phase—Using Ambiguity Queue to improve results

a. Set Ambiguity Queue Thresholds

b. Run searches against the target Internet or intranet, using the sample SearchUnitList defined above in step e.

c. Rate the search results, putting entries which fall below the thresholds defined in step 2a. on the appropriate Ambiguity Queue.

d. Determine Ratings for entries in the Ambiguity Queues and add these items to the Core Group

e. Process entries in Ambiguity Queues, determining Ratings and adding manually rated items to the Core Group

f. Repeat steps 1d-1f above.

g. Repeat steps 2c-2f until the percent of search results which hit the Ambiguity Queue is below the Target Ambiguity Queue percentage.

“Summary of Functionality”

This system provides a new way for a user to search an internet or intranet, and get back not just standard search results but a measure of the strength of the search results for one or more information dimensions and information domains. The system makes it possible for the user to define his or her own group of “things which can be measured (i.e. Ratable Units), which could be anything a search could return (images, audio files, etc) and to define the method by which ratings are determined for these things. The inventions also includes as examples a set of viable Ratable Units (implemented as Java Classes), methods for determining ratings for these units, and methods for testing the accuracy of these rating algorithms. The system includes an automatic mechanism for populating a standard dictionary with ratings, once a Core Group has been populated. Additionally, the system includes a method for gaining incremental improvement in rating accuracy by putting questionable results on a ambiguity queue, having these results rated through an external process (such as manual rating), and then feeding the new ratings back into the dictionary as Core Group members, and re-running the automatic population and validation process.

Glossary of Terms

Ambiguity Queue

A work queue into which search results are placed which the Content Analysis Engine cannot analyze with a high degree of confidence (ie cannot provide a rating with a High Confidence level.) This queue can be serviced by another application or a human being, the goal being to provide an accurate rating.

Confidence Level

The level of confidence in the validity of the Rating for a given item to be rated.

Content Analysis Engine

The subsystem which analyzes the results returned by the Content Retrieval Engine to determine the Strength of each hit for a particular Information Domain and Information Dimension.

Content Retrieval Engine

The subsystem which formulates the search keys used to search the web for information relating to Information Domains and Information Dimensions. The Content Retrieval Engine also performs the actual search.

Information Dimension

A particular criteria of interest within an information domain. Information Dimensions usually are measured along a continuum as opposed to being simply present or not present. Examples of Information Dimensions are Size (smallest-largest), Speed (slowest-fastest), Emotional Tone (negative-Positive).

Information Domain

An information topic or category of interest. (Not to be confused with Internet Domains). An Information Domain of interest might be very limited (for-instance “Bill Gates” or cover an entire field (for-instance “Sports”).

Rating

A number which indicates the strength of a word or phrase within a particular Information Dimension. For example “Huge” has a high rating within the Information Dimension of Size.

Reference Count

The number of items of information used to determine a Composite Rating for a given site.

While a specific embodiment of the invention has been shown and described, it is to be understood that numerous changes and modifications may be made therein without departing from the scope and spirit of the invention as set forth in the appended claims.

What I claim is:

1. A method of searching a network, such as the Internet, using a computer operatively coupled for communication with the network, comprising:
(a) invoking at least one Content Retrieval Object (CRO) defining the information dimension to be searched;
(b) conducting the search for the particular information dimension and particular information domain on the network;
(c) retrieving the results from the search and storing it in memory;
(d) analyzing the results of the search stored in memory from said step (c) for the information dimension and information domain for determining a rating for each ratable unit of the information dimension by using a Content Analysis Engine (CAE); and
(e) storing the results of said (d) in memory.

2. The method of searching a network, such as the Internet, using a computer operatively coupled for communication with the network, according to claim 1, wherein said step (a) comprises:
(f) using a Content Retrieval Engine (CRE) stored in memory for searching for the particular information domain, said CRE invoking at least one CRO for the particular information dimension needed for formulating the necessary search keys for performing the search of said step (b).

3. The method of searching a network, such as the Internet, using a computer operatively coupled for communication with the network, according to claim 2, wherein said step (f) comprises:
(g) retrieving from an Information Dimension Dictionary the search keys required for performing the search of said step (b).

4. The method of searching a network, such as the Internet, using a computer operatively coupled for communication with the network, according to claim 3, further comprising:
(h) creating an Information Dimension Dictionary for different Information Dimensions for use by said CROs for conducting the search of said step (b);
(i) said step (h) comprising storing definitions in the Dimensions Dictionary by a collection of “Definition Rating/Frequency Objects, each having a class definition rating and frequency, a string-information dimension, a rating for the particular definition in each Information Dimension, a float confidence level, and a float frequency.

5. The method of searching a network, such as the Internet, using a computer operatively coupled for communication with the network, according to claim 4, wherein said step (h) comprises initially starting out with a core group of definitions for which said step (I) has been performed; and
(j) performing said step (I) a plurality of times for other definitions in said Information Dimension Dictionary in order to create and rate other definitions of said step (I) so as to also comprise said collection of said step (I).

6. The method of searching a network, such as the Internet, using a computer operatively coupled for communication with the network, according to claim 5, wherein said step (j) comprises using dictionary threshold rating ranges, dictionary threshold match count, and dictionary threshold confidence level for rating each definition in each information dimension; said step (I) utilizing said Content Analysis Engine (CAE)

7. The method of searching a network, such as the Internet, using a computer operatively coupled for communication with the network, according to claim 4, wherein said step (f) comprises analyzing the search results of said step (b) by assigning a composite rating to each ratable unit by comparing the ratable unit to the definitions of said Information Dimension Dictionary in order to arrive a rating value for that ratable unit for the particular information dimension, where said composite rating assigns a probable value to each ratable unit as to the likelihood that it is relevant to the particular information dimension be searched.

8. A method of searching on the Internet, or other network, comprising:
(a) choosing an Information Domain for which one searches for at least one Information Dimension;
(b) searching the network for every site that has a match between said Information Domain and Information Dimension;
(c) retrieving the search results;
(d) analyzing the search results for determining the probability that each unit retrieved from said search contains said Information Dimension.

9. The method according to claim 8, wherein said step (d) comprises comparing the unit to entries in an Information Dimension Dictionary, by means of the probability that said unit refers to said Information Dimension; and assigning a confidence level thereto.

10. A method of creating an Information Dimension Dictionary for use in searching a network, such as the Internet, using a computer operatively coupled for communication with the network, comprising:
(a) storing core definitions in the Information Dimension Dictionary by a collection of “Definition Rating/Frequency Objects, each having a class definition rating and frequency, a string-information dimension, a rating for the particular definition in each Information Dimension, a float confidence level, and a float frequency;
(b) for each information dimension, using said core definitions and comparing said core definitions to other remaining definitions having a similar key word as in said core list for generating in these other remaining definitions a respective said collection at a specific composite rating and confidence level based on said core list;
(c) sending the results of said step (b) to a Content Analysis Engine for providing a rating for each remaining definition.
